(19) United States
(12) Patent Application Publication
(10) Pub. No.: US 2019/0084078 A1
(43) Pub. Date: Mar. 21, 2019

(54) ULTRASONIC WELDING DEVICE AND ULTRASONIC WELDING METHOD

(71) Applicant: HONDA MOTOR CO., LTD., Tokyo (JP)

(72) Inventors: Masaki Kunigami, Tochigi (JP); Hitoshi Saito, Tochigi (JP); Tsugio Masuda, Tochigi (JP); Nobuhiro Fueki, Tochigi (JP); Shinzo Urushidani, Tochigi (JP); Tatsuya Okunaka, Tochigi (JP); Tomoyuki Kanamaru, Tochigi (JP)

(21) Appl. No.: 16/085,195

(22) PCT Filed: Feb. 27, 2017
(86) PCT No.: PCT/JP2017/007563

§ 371 Date: Sep. 14, 2018

(30) Foreign Application Priority Data
Mar. 18, 2016 (JP) 2016-056096

(51) Int. Cl. B23K 20/10; H01R 43/02

(52) U.S. Cl. CPC B23K 20/10; B29C 65/086; H01R 43/0207

(57) ABSTRACT

A device capable of improving estimation precision of coating removal completion of a conductor which is an ultrasonic welding target is provided. A displacement speed v of the horn (11) is chronologically measured. A progress situation of the melting and removal of an insulating coating C0 (a synthetic resin included in the insulating coating C0) between both conductors C1 and C2 which are welding targets is estimated based on a transition form from a “first stable state” in which the displacement speed v is stable in a first speed zone to a “second stable state” in which the displacement speed v is stable in a second speed zone of a higher speed zone than the first speed zone in a course in which the displacement speed v of the horn (11) increases.

### TECHNICAL FIELD

The present invention relates to a technique for welding conductors to each other by ultrasonic vibration energy.

### BACKGROUND ART

Ultrasonic welding methods of welding one conductor and the other conductor coated with synthetic resins have been proposed (for example, see Patent Literatures 1 and 2). According to the ultrasonic welding methods, at least the synthetic resin with which the one conductor is coated is first melt by the ultrasonic vibration energy of a horn with a welding target interposed between the horn and an anvil, and is removed from between the both conductors. Subsequently, the both conductors are welded to each other.

A method of realizing ultrasonic welding while preventing a variation in a welding strength of the both conductors caused due to a variation in the ultrasonic vibration energy has been proposed (for example, see Patent Literature 3). According to the method, a product of a voltage applied to a vibration element vibrating the horn and a current flowing in the vibration element is calculated as a work rate given to a welding target via the horn. Then, when a rate of change in the work rate becomes equal to or less than a first predetermined value, and subsequently becomes equal to or greater than a second predetermined value greater than the first predetermined value, the coating is determined to be removed from between the conductors.

### CITATION LIST

### Patent Literature

### Patent Literature 1: Japanese Patent Application Laid-Open No. 2000-263248

### Patent Literature 2: Japanese Patent Application Laid-Open No. 2006-024590

### Patent Literature 3: Japanese Patent No. 4456640

### SUMMARY OF INVENTION

### Technical Problem

However, since there is a transitional period in which conductor welding starts and the coating removal further progresses, there is a possibility that it is difficult to determine whether the removing of the coating is completed based on a change in the work rate. Therefore, there is a possibility that, for example, the conductor is damaged due to excessive ultrasonic vibration energy in addition to the possibility that the welding strength of the conductor is insufficient due to small ultrasonic vibration energy.

Accordingly, an object of the invention is to provide a device and the like capable of improving estimation precision of coating removal completion of conductors which are ultrasonic welding targets.

### Solution to Problem

According to an aspect of the invention, there is provided an ultrasonic welding device including: a horn that is vibrated by a piezoelectric element; an anvil that is disposed to face the horn; and a control device. A synthetic resin is melted to be removed from between one conductor and another conductor by displacing the horn in a superimposing direction of the one conductor and the other conductor while ultrasonically vibrating the horn in a state in which the one conductor and the other conductor superimposed via the synthetic resin are interposed by the horn and the anvil, and the one conductor and the other conductor are welded.

In the ultrasonic welding device according to the aspect of the invention, the control device includes a measurement element that chronologically measures a displacement speed of the horn and an estimation element that estimates a progress situation of the melting and removal of the synthetic resin between the one conductor and the other conductor based on a transition form from a first stable state in which the displacement speed is stable in a first speed zone to a second stable state in which the displacement speed is stable in a second speed zone of a higher speed zone than the first speed zone in a course in which the displacement speed of the horn measured by the measurement element increases.

In the ultrasonic welding device according to the aspect of the invention, the estimation element preferably estimates that the melting and removal of the synthetic resin between the one conductor and the other conductor have ended at an ending time point of a transition period from the first stable state to the second stable state.

### Advantageous Effects of Invention

The “first stable state” is a state in which the displacement speed of the horn is stable in the first speed zone and corresponds to a state before start of or an early stage of melting and removal of the synthetic resin between the both conductors by the ultrasonic vibration energy of the horn. The “second stable state” is a state in which the displacement speed of the horn is stable in the second speed zone of a higher speed zone than the first speed zone and is equivalent to an ending stage of or a state after end of the melting and removal of the synthetic resin between the both conductors. Therefore, it is possible to improve estimation precision of a progress situation of the melting and removal of the synthetic resin between the both conductors based on a transition form from the first stable state to the second stable state in a course in which the displacement speed of the horn increases.

### BRIEF DESCRIPTION OF DRAWINGS

FIG. 1 is a diagram illustrating a configuration of an ultrasonic welding device according to an embodiment of the invention.

FIG. 2 is a diagram illustrating an ultrasonic welding situation estimation method according to an embodiment of the invention.

FIG. 3 is a diagram illustrating an ultrasonic welding situation estimation method according to another embodiment of the invention.

FIG. 4 is a diagram illustrating a change form of a displacement amount of a horn.

### DESCRIPTION OF EMBODIMENTS

### (Configuration)

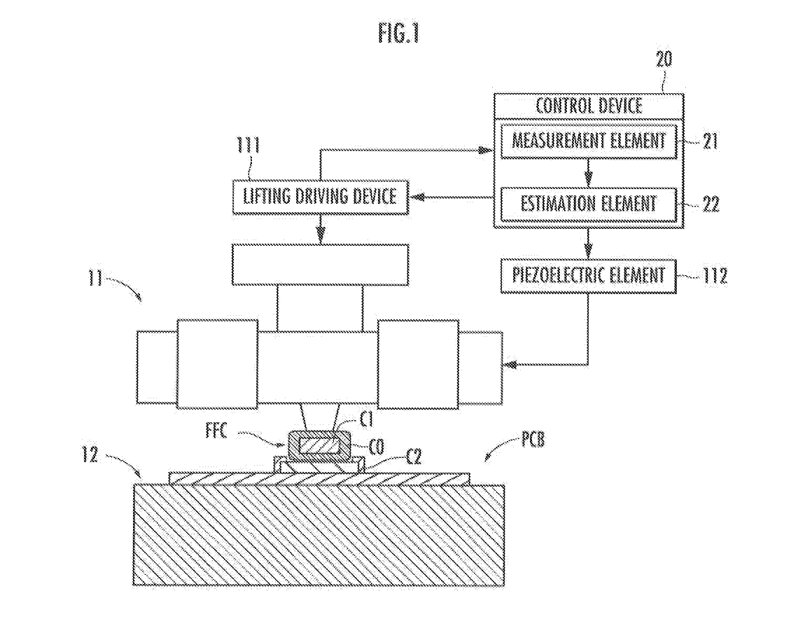

An ultrasonic welding device according to an embodiment of the invention, as illustrated in FIG. 1, includes a horn 11 (or a chip), an anvil 12 that is disposed below the horn 11 to face the horn 11, a lifting driving device 111 that drives the horn 11 in the vertical direction, a piezoelectric element 112 (an ultrasonic vibrator) that ultrasonically vibrates the horn 11, and a control device 20. A lower end portion of the horn 11 is formed so that an upper bottom surface is formed downward in a substantially truncated cone shape, but can be appropriately changed to, for example, a shape in which a front end of a conductor has a plurality of protrusions having belt-like or spotted front ends according to a disposition form of the conductor which is a welding target. The upper end portion of the anvil 12 is substantially planar, but an unevenness may be appropriately formed in accordance with the shape of the horn 11.

The control device 20 includes a computer (which includes an arithmetic processing unit (CPU), a memory (a storage device) such as a ROM or a RAM, an I/O circuit, and the like). The control device 20 controls an operation of each of the lifting driving device 111 and the piezoelectric element 112. The control device 20 includes a measurement element 21 and an estimation element 22. The elements 21 and 22 each include an arithmetic processing unit that reads a program and data necessary from the storage device and performs an arithmetic process to be described below according to the program and the data.

As welding targets by the ultrasonic welding device, for example, a first conductor C1 (one conductor) formed of metal for a flexible flat cable (FFC) and a second conductor C2 (the other conductor) formed of metal for a printed circuit board (PCB) are adopted. The FFC includes an insulating coating C0 formed of a synthetic resin that covers the first conductor C1 in addition to the first conductor C1. The PBC includes a board supporting the second conductor C2.

Only the single first conductor C1 is illustrated to simplify the drawings, but the plurality of first conductors C1 arranged in parallel in the horizontal direction and extending in the vertical direction in the FFC is covered with the insulating coating C0 so that the first conductors C1 are electrically isolated from each other. Similarly, only the single second conductor C2 is illustrated, but the plurality of second conductors C2 is installed on the board in the PCB.

In addition to the conductors included in the FFC and the PCB, conductors included in the plurality of FFCs or conductors included in the FFC and a flexible printed circuit (FPC) may be considered to be welded targets.

### (Function)

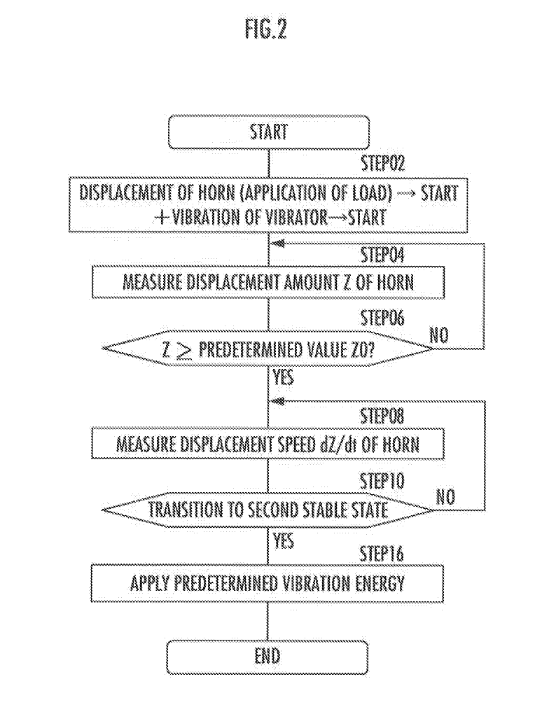

An ultrasonic welding method accompanied with an ultrasonic welding situation estimation method performed by an ultrasonic welding device that has the foregoing configuration will be described. First, as illustrated in FIG. 1, the FFC and the PCB are interposed to be superimposed vertically between the horn 11 and the anvil 12. At this time, each of the first conductors C1 of the FFC and each of the second conductors C2 of the PCB are in a state of being vertically superimposed with each other with the insulating coating C0 of the FFC interposed therebetween. From this state, the horn 11 is displaced to approach the anvil 12 by the lifting driving device 111, and thus by applying a load in the vertical direction to the FFC and the PCB and by applying an alternating-current voltage with a high frequency to the piezoelectric element 112, the horn 11 is ultrasonically vibrated (in the horizontal direction in the drawing) (STEP 02 of FIG. 2).

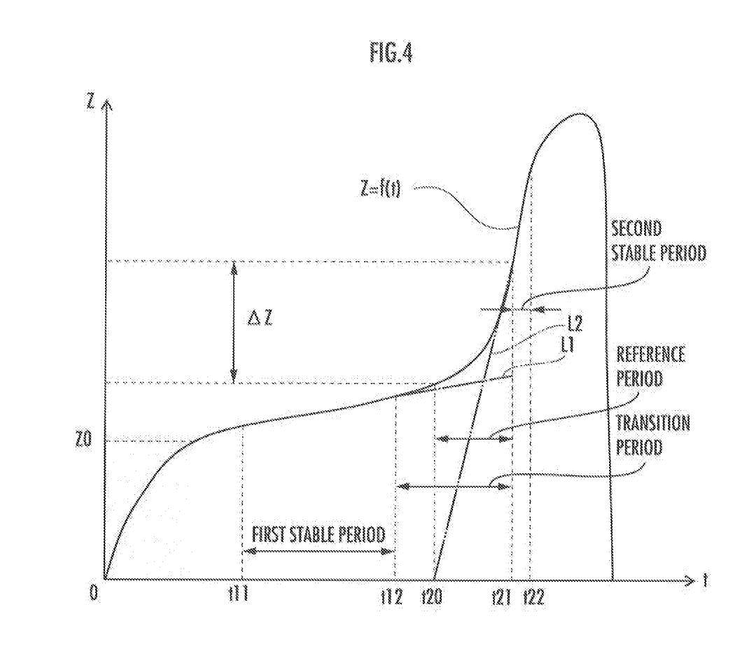

At this time, the measurement element 21 of the control device 20 measures a displacement amount Z chronologically based on an output signal from a displacement amount sensor (not illustrated) according to the displacement amount Z (a descending amount) of the horn 11 after start of the load application (STEP 04 of FIG. 2). Thereafter, until welding of the first conductor C1 and the second conductor C2 is completed, the displacement amount of the horn 11 is changed, as illustrated in, for example, FIG. 4.

A strain amount ε₁(t) (equivalent to the displacement amount Z of the horn 11) of the insulating coating C0 formed of a synthetic resin when a constant external force σ₀ is applied at time t=0 is approximately expressed as in Expression (1) in accordance with the Kelvin-Voigt model. In this model, elasticity and viscosity characteristics of the synthetic resin are expressed by a parallel spring (elastic coefficient: E) and a damper (attenuation coefficient: η).

ε₁(t)=(σ₀/E){1−exp(−t/(η/E))} (1)

A time change form of the displacement amount Z of the horn 11 at t=0 to t₁₂ in FIG. 4 is in conformity with Expression (1).

On the other hand, a strain amount ε₂(t) in a transient creep region of the conductors C1 and C2 formed of metal is approximately expressed as in Expression (2) using a material constant A, a diffusion coefficient D, and a coefficient G of the metal.

ε₂(t)=A·D·(σ₀/G)ⁿ×t (2)

That is, a time change form of the displacement amount Z of the horn 11 at t=t₂₁ to t₂₂ in FIG. 4 is consistent with Expression (2).

The temperatures of the FFC and the PCB at spots interposed between the horn 11 and the anvil 12 are locally increased by the ultrasonic vibration energy of the horn 11, and the insulating coating C0 of the FFC is locally melted. The melted insulating coating C0 (the synthetic resin) is gradually removed from between the horn 11 and the anvil 12 because of a load of the horn 11 and the anvil 12 in the vertical direction. At this time, the insulating coating C0 between the first conductor C1 and the second conductor C2 is also melted and is gradually removed from between the first conductor C1 and the second conductor C2.

The estimation element 22 of the control device 20 determines whether the displacement amount Z of the horn 11 is equal to or greater than a predetermined value Z₀ (STEP 06 of FIG. 2). In a state in which the displacement amount Z of the horn 11 is less than the predetermined value Z₀, the melting of the insulating coating C0 is not progressed and determination to be described below based on a displacement speed dZ/dt of the horn 11 is not necessary. Therefore, this determination is performed. This determination process may be omitted.

When the determination result is negative (NO in STEP 06 of FIG. 2), the displacement amount Z of the horn 11 is measured again (STEP 04 of FIG. 2). When the determination result is positive (YES in STEP 06 of FIG. 2), the measurement element 21 measures a displacement speed v=dZ/dt (descending speed) of the horn 11 (STEP 08 of FIG. 2). For example, the displacement amount Z measured in the above-described way is input to a differentiation circuit (not illustrated) included in the measurement element 21 and a value output from the differentiation circuit is obtained as the displacement speed v of the horn 11. A time series of the displacement amount Z of the horn 11 is stored and retained in a storage device included in the control device 20.

The displacement speed v is expressed as a slope of the curve line Z=f(t) indicating a time change form of the displacement amount Z on a 2-dimensional coordinate system (t-Z plane) in which a time t and the displacement amount Z illustrated in FIG. 4 are coordinate values.

After the displacement amount Z of the horn 11 exceeds the predetermined value Z₀, a “first stable state” in which the displacement speed v is stable in a first speed zone during the first stable period [t₁₁, t₁₂] is realized. The first speed zone is a speed zone that is defined by a lower limit and an upper limit of a slope of the curve line Z=f(t) in the first stable period. In FIG. 4, a tangential line L1 of the curve line Z=f(t) at an ending time point t=t₁₂ of the first stable state is indicated by a one-dot chain line. The slope of the tangential line is approximately (σ₀/η) according to Expression (1). The slope of the curve line Z=f(t) during the first stable period approximately follows the tangential line L1. The “first stable state” is equivalent to an early stage of or a state before start of the melting and removal of the synthetic resin (the insulating coating C0) between the both conductors C1 and C2 by the ultrasonic vibration energy of the horn 11.

Next, the displacement speed v increases during a period [t₁₂, t₂₁], and a “second stable state” in which the displacement speed v is stable in a second speed zone during the second stable period [t₂₁, t₂₂] is realized. The second speed zone is a speed zone that is defined by a lower limit and an upper limit of a slope of a curve line Z=f(t) during the second stable period. In FIG. 4, a tangential line L2 of the curve line Z=f(t) at a starting time point t=t₂₁ of the second stable state is indicated by a two-dot chain line. The slope of the tangential line is approximately A·D·(σ₀/G)ⁿ according to Expression (2). The slope of the curve line Z=f(t) during the second stable period approximately follows the tangential line L2. As apparent from the fact that the sloe of the curve line Z=f(t) is greater in the second stable period than in the first stable period, the second speed zone is a higher speed zone than the first speed zone. The “second stable state” is equivalent to an ending stage of or a state after end of the melting and removal of the synthetic resin (the insulating coating C0) between the both conductors C1 and C2.

The estimation element 22 determines whether the first stable state has transitioned to the second stable state in a course in which the displacement speed v increases, based on the time change form of the displacement speed v of the horn 11 (STEP 10 of FIG. 2). For example, when the displacement speed v of the horn 11 is stable near a first value (σ₀/η) and subsequently increases and reaches a second value A·D·(σ₀/G)ⁿ greater than the first value or becomes stable near the second value, the first stable state is determined to transition to the second stable state. This determination is equivalent to determination performed to determine whether the melting and removal of the synthetic resin included in the insulating coating C0 between the both conductors C1 and C2 has ended.

When the determination result is negative (NO in STEP 10 of FIG. 2), the displacement speed v of the horn 11 is measured again (STEP 08 of FIG. 2). Conversely, when the determination result is positive (YES in STEP 10 of FIG. 2), predetermined vibration energy is applied to weld the conductors (STEP 16 of FIG. 2). The predetermined vibration energy necessary to weld the conductors is set based on, for example, an ultrasonic welding device condition such as a pressurization force, amplitude, and an ultrasonic application time. As a relatively simple setting method for the predetermined vibration energy necessary to weld the conductors, for example, a pressurization force, amplitude, an ultrasonic application time, or the like may be calculated as a setting value for vibration energy through pre-calculation or an experiment. Thereafter, a series of processes is completed.

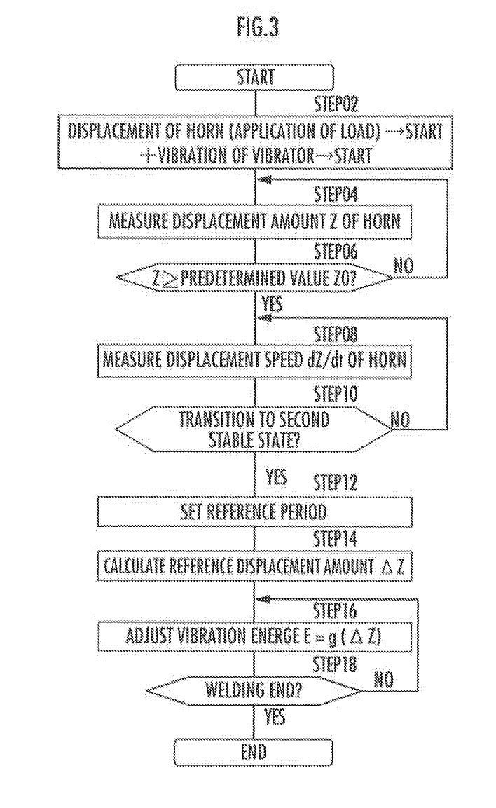

By utilizing a change in the displacement speed, it is also possible to improve welding quality. Hereinafter, a method of setting the vibration energy will be described. Since each of STEP 02 to STEP 10 of FIG. 3 is similar to each of STEP 02 to STEP 10 of FIG. 2, the description thereof will be omitted.

First, the control device 20 sets a reference period (STEP 12 of FIG. 3). Specifically, a time point t=t₂₀ equivalent to an intersection between a time axis and a tangential line L2 of a curve line Z=f(t) at an ending time point t=t₂₁ (a starting time point of the second stable state) of a transition period [t₁₂, t₂₁] from the first stable state to the second stable state is obtained. A period [t₂₀, t₂₁] in which the time point t=t₂₀ is a starting time point and a starting time point t=t₂₁ of the second stable state is an ending time point is set as the reference period.

Further, the control device 20 calculates the displacement amount ΔZ of the horn 11 during the reference period as a reference displacement amount (STEP 14 of FIG. 3). The magnitude of the reference displacement amount ΔZ indicates a speed fluctuation of the transition form from the first stable state to the second stable state. That is, as the reference displacement amount ΔZ increases, the first stable state abruptly transitions to the second stable state, and furthermore a temperature increase speed and a melting speed of the insulating coating C0 by the ultrasonic energy of the horn 11 are higher.

Subsequently, the control device 20 controls amplitude of an alternating-current voltage applied to the piezoelectric element 112 based on the reference displacement amount ΔZ so that the magnitude of the ultrasonic vibration energy E=g(ΔZ) of the horn 11 can be adjusted (STEP 16 of FIG. 3). Specifically, the energy E is adjusted so that the ultrasonic vibration energy E decreases step by step or continuously as the reference displacement amount ΔZ increases.

Then, the estimation element 22 determines whether the welding of the first conductor C1 and the second conductor C2 is completed (STEP 18 of FIG. 3). For example, the determination may be performed depending on whether the displacement speed v of the horn 11 decreases from the second speed zone to a lower speed by a given value or more. When the determination result is negative, the ultrasonic vibration energy E=g(ΔZ) of the horn 11 is continuously adjusted (STEP 16 of FIG. 3). Conversely, when the determination result is positive, the application of the voltage to the piezoelectric element 112 is stopped and the ultrasonic vibration of the horn 11 is stopped. Further, the horn 11 is driven to be lifted by the lifting driving device 111 (see a decrease stage of the curve line Z=f(t) of FIG. 4).

### Advantageous Effects

Based on a transition form from the first stable state to the second stable state in the course in which the displacement speed v of the horn 11 increases (a state in which the displacement acceleration α=dv/dt=d²Z/dt² is equal to or greater than 0), a progress situation of the melting and removal of the synthetic resin included in the insulating coating C0 between the both conductors C1 and C2 is estimated.

For example, the fact that the displacement speed v of the horn 11 is high (or the displacement amount Z is large) during the transition period (or the reference period) suggests that elasticity and viscosity of the synthetic resin included in the insulating coating C0 during the period is low or the temperature is high and furthermore the melting and removal of the synthetic resin rapidly progresses. Therefore, by performing control such that the ultrasonic vibration energy E of the horn 11 is relatively low when the reference displacement amount ΔZ is large, the excessive ultrasonic vibration energy E at the time of welding the both conductors C1 and C2 is prevented. Therefore, it is possible to reliably realize sufficient welding strength between the conductors C1 and C2. In contrast, by performing control such that the ultrasonic vibration energy E of the horn 11 is relatively high when the reference displacement amount ΔZ is small, the small ultrasonic vibration energy E at the time of welding the both conductors C1 and C2 is prevented. Therefore, it is possible to reliably realize sufficient welding strength between the conductors C1 and C2.

### Other Embodiments of Invention

In the foregoing embodiments, the ending time point of the melting and removal of the insulating coating C0 may be estimated according to a long or short length of a period from the starting time point t=t₁₂ of the transition period to a time point at which the displacement acceleration α=d²Z/dt² of the horn 11 becomes 0 or a change form of the displacement amount Z of the horn 11 during the period. Specifically, a smaller correction value may be set as the period is shorter, and a future time point at which the correction value is added to the time point at which the displacement acceleration α=d²Z/dt² of the horn 11 becomes 0 may be estimated as the ending time point of the melting and removal of the insulating coating C0. The correction value may be set so that the correction value decreases step by step or continuously as the displacement speed v of the horn 11 during the period is higher.

### DESCRIPTION OF REFERENCE NUMERALS

11 horn
12 anvil
111 lifting driving device
112 piezoelectric element (ultrasonic vibrator)
20 control device
21 measurement element
22 estimation element
C1 first conductor (one conductor)
C2 second conductor (the other conductor)
R insulating coating (synthetic resin)

1. An ultrasonic welding device comprising:
a horn that is vibrated by a piezoelectric element;
an anvil that is disposed to face the horn; and
a control device,
wherein a synthetic resin is melted to be removed from between one conductor and another conductor by displacing the horn in a superimposing direction of the one conductor and the other conductor while ultrasonically vibrating the horn in a state in which the one conductor and the other conductor superimposed via the synthetic resin are interposed by the horn and the anvil, and the one conductor and the other conductor are welded, and
wherein the control device includes
a measurement element that chronologically measures a displacement speed of the horn, and
an estimation element that estimates a progress situation of the melting and removal of the synthetic resin between the one conductor and the other conductor based on a transition form from a first stable state in which the displacement speed is stable in a first speed zone to a second stable state in which the displacement speed is stable in a second speed zone of a higher speed zone than the first speed zone in a course in which the displacement speed of the horn measured by the measurement element increases.

2. The ultrasonic welding device according to claim 1,
wherein the estimation element estimates that the melting and removal of the synthetic resin between the one conductor and the other conductor have ended at an ending time point of a transition period from the first stable state to the second stable state.

3. An ultrasonic welding method of melting a synthetic resin to remove the synthetic resin from between one conductor and another conductor by displacing a horn vibrated by a piezoelectric element in a superimposing direction of the one conductor and the other conductor while ultrasonically vibrating the horn in a state in which the one conductor and the other conductor superimposed via the synthetic resin are interposed by the horn and an anvil disposed to face the horn, and welding the one conductor and the other conductor, the method comprising:
a measurement step of chronologically measuring a displacement speed of the horn; and
an estimation step of estimating a progress situation of the melting and removal of the synthetic resin between the one conductor and the other conductor based on a transition form from a first stable state in which the displacement speed is stable in a first speed zone to a second stable state in which the displacement speed is stable in a second speed zone of a higher speed zone than the first speed zone, in a course in which the displacement speed of the horn measured in the measurement step increases.
